(19) United States
(12) Patent Application Publication
(10) Pub. No.: US 2004/0034575 A1
(43) Pub. Date: Feb. 19, 2004

(54) Computer system for purchasing and managing pets and a method thereof

(76) Inventor: Bong Kyun Oh, Seoul (KR)

Correspondence Address: CHA & REITER, LLC, 210 ROUTE 4 EAST, PARAMUS, NJ, 07652, US

(21) Appl. No.: 10/399,169

(22) PCT Filed: Oct. 13, 2001
(86) PCT No.: PCT/KR01/01728

(30) Foreign Application Priority Data
Oct. 13, 2000 (KR) 2000/60183
Oct. 12, 2001 (KR) 2001/63144

(51) Int. Cl. G06F 17/60

(52) U.S. Cl. 705/27

(57) ABSTRACT

Disclosed is a system for purchasing and managing pets. The system comprises a customer node (100), a server node (120), and a supplier node (170), each node being connected by Internet. According to a request for purchase, training, referral, quarantine, etc. of pets from the customer node, information about various pets and a request form are displayed on the customer node. The customer fills in pertinent empty spaces in the request form to achieve a wanted trade. The request form has fundamental purchase items (FPI) containing contents that the customer must select. The request form further has an optional purchase item (OPI) that is optionally selected when the customer wants additional purchase to the FPIs out of free will. But the OPI doesn't directly affect arrangement of the trade. The request form further has a requisite purchase item (RPI) that the customer automatically attains without a separate selection once the trade is arranged by the selection among the FPIs. The RPI is cancelable later.

### TECHNICAL FIELD

The present invention relates to a computer system for purchasing and managing pets using a computer network through which a series of actions for pets ranging from purchase to pregnancy, training, custody, quarantine, and so on can be attainable.

### BACKGROUND ART

Interest in pets is not a local matter of one specific country but is on a continuously increasing trend all over the world. The species of animals treated as pets have been extending from dogs and cats to fishes, birds, and even to reptilia such as iguanas.

Purchase and management of pets have not been systematically carried out in light of various matters happening in relation to the pets, but have been individually carried out based on off-line. By way of example, when a person wants to purchase a dog, he/she generally purchases the dog in a pet dog shop, an animal hospital or the like. This means that a purchaser and a seller should individually and directly contact with each other to trade. Of course, owing to development of the Internet, there have currently appeared many web sites such that sellers provide services through web pages with respect to pets. However, the web sites are just limited to electronically displaying information on pets by using a convenient means, computer. In consequence, further constructive and progressive services are not rendered by the web sites and the conventional practice in which consumers and sellers individually contact is repeated over and over again. Especially, when unexpected incident such as disease, damage, injury or the like happens to pets after having purchased them, what purchasers usually do at best is to demand compensation for the incident according to provisions of ‘Rights to obtain proper compensation for damages’.

Some companies provide one or more combined services in connection with the pregnancy, custody to a pet hotel, training, and so on after the purchase of pets. But these companies have a weakness in dealing with compensation for disease, damage or death of pets caused while the service is provided.

Recently a pet insurance has appeared to make up for loss, disease, damage, or death resulted from disease or damage. To get the beneficiary of the pet insurance, a pet owner has to contact with an insurance company selling the pet insurance, directly or through an agency by on-line or off-line. Therefore, it is desirous to develop an insurance system addressed to services rendered in relation with possible matters which may happen when purchasing pets, when taking proceedings for pregnancy of the pet, or when consulting about training of the pet. In particular, an insurance system that is automatically subscribed via on-line in addition to the desired behavior of consumption to pets is also worthy of consideration

Especially, when people wish with their pet to make a journey, to go abroad for study, or to emigrate to a foreign country, the contents and procedures of quarantine regulations, entry and departure formalities, and so on are diverse depending on the relevant country, and thus it is really burdensome for the owner to go through all the formalities for quarantine. Further, preparing a cage for carrying the pet followed when entering and departing, paying costs including airfare, and contracting Transit Clause which usually provides the pet owner's responsibility for damage or death of the pet maybe caused during the transportation, all of which are hard affairs to endure to the owner of pets.

### DISCLOSURE OF INVENTION

In accordance with the present invention, a computer system is provided for purchasing and managing pets, the computer system comprising a customer node, a server node (central control system), and a supplier node. When a customer logs on to the server node through the Internet and selects a subject area, the customer receives on-line catalogues of pets, and accordingly is able to get a desired service through a request form.

The request form is a sort of electronic contract having a plurality of blanks to be filled out by the customer using a keyboard or a mouse. The electronic contract consists of three items, i.e., Fundamental Purchase Items(FPI), Optional Purchase Items(OPI), and Requisite Purchase Items(RPI).

The FPI is mainly composed of particulars on traditional and common practice, custom, and routine in a trade, which might be made through on-line or off-line, in a pertinent subject area, e.g., purchase, pregnancy, training, custody, funeral, and quarantine. The FPI includes minimum items for successful trade. For example, when a customer wishes to purchase a pet dog, the customer should select or designate detailed items or contents within the FPI itself to specify a pet dog's kind, sex, age and the like. The OPI is a kind of service for allowing the customer to freely determine additional purchases with respect to the subject area. Thus, irrespective of the customer's selection in the OPI, a trade is automatically made by the selection or designation of details in the FPI. The RPI is a service that the customer can automatically attain without a separate selection, once a specific item is selected from the FPI and so the trade is arranged. Even though the RPI is obtained irrespective of the customer's will, it is out of question that the RPI can be canceled when the customer does not want the service. That is to say, the customer can express his/her intension of cancellation on the final point when the contract is completed, or before requirements of the RPI are not met after the contract is completed (e.g., in case of insurance, before an insurance contract is entered into with an insurance company).

Furthermore, items or contents constituting the respective FPI, the OPI, and the RPI are exchangeable with one another. The exchange can be made by the customer's request, or the supplier' or the server's request. In each subject area, the RPI may have a plurality of sub optional items, and the customer has to make a separate selection in this case.

The present invention also provides a method for trading between a customer and a server system through a network in connection with a pet. This method includes a step of transmitting a service request for purchase, pregnancy, training, funeral, quarantine, and management of the pet from the customer to the server system. The method further includes a step of transmitting a request form having a plurality of FPIs and RPIs together with information of pets to the customer in response to the service request from the customer. To receive the service through the desired trade, the customer should select at least one item of the FPIs. But the customer does not need to intentionally make a selection of the RPIs. Once the trade is accomplished by performing a selection of detailed items in the FPIs, the RPIs is accordingly attained. Next, the method of the present invention further includes a step of selecting at least one item that is desired by the customer among the plurality of FPIs in the request form.

### BRIEF DESCRIPTION OF THE DRAWINGS

Further objects and advantages of the invention can be more fully understood from the following detailed description taken in conjunction with the accompanying drawing in which:

FIG. 1 is a block diagram of a system for purchasing and managing pets according to the present invention;

FIG. 2 is a flow chart illustrating a process of purchasing pets in the system according to the present invention;

FIG. 3 is a flow chart illustrating a process of training pets in the system according to the present invention; and

FIG. 4 is a flow chart illustrating a process of quarantining pets in the system according to the present invention.

### BEST MODE FOR CARRYING OUT THE INVENTION

The present invention will now be described in detail in connection with preferred embodiments with reference to the accompanying drawings. For reference, like reference characters designate corresponding parts throughout several views.

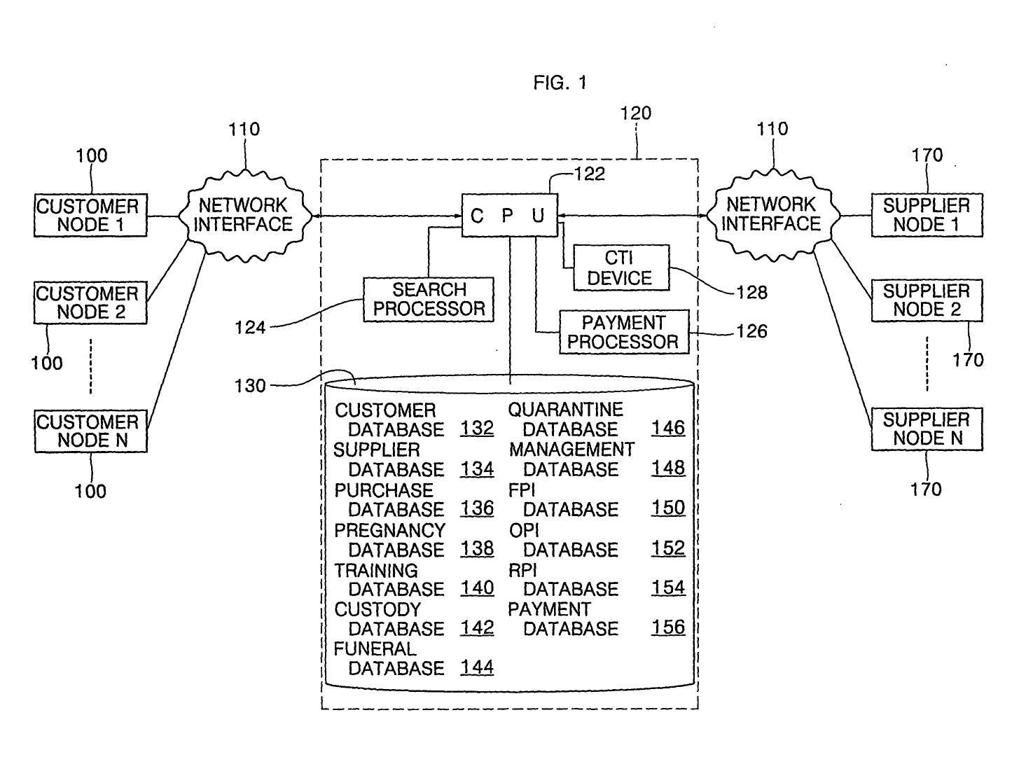

FIG. 1 illustrates a preferred embodiment of a system for purchasing and managing pets according to the present invention. The system includes a customer node 100, a server node 120 as a central control system, and a supplier node 170. The respective nodes are connected by a network interface 110 like Internet. Connection of the respective nodes may also be achieved by a dedicated line, a cellular phone or a personal communication service(PCS).

The customer node 100 and the supplier node 170 each is a personal computer or a computer workstation having a communication interface and is provided with a web browser software such as Netscape Navigator that is manufactured by Netscape Inc.

The central control system, i.e., the server node 120, includes a central processing unit(CPU) 122, a search processor 124, a payment processor 126, and a CTI device 128.

The central control system 120 is a personal computer, a workstation or a main frame computer that has sufficient processing capability and memory capacity, and constructed to serve as a web server. The search processor 124 searches for necessary information from a data storage device upon request of a user like a customer or a supplier, and transmits the information to the user.

The payment processor 126 may be constructed as a part of the central processing unit(CPU) 122, and supports users in charge, payment, remittance, etc.

The CTI device 128 transmits and receives information to and from users, i.e., between the customer node 100 and the supplier node 170. Thus, the CTI device 128 can transmit and receive desired information through an electronic mail, a facsimile and a cellular phone. The CTI is an abbreviation of Computer Telephony Integration.

The data storage device 130 includes information about pets, and stores databases used for the trade according to the present invention. It is desirable that the stored databases are defined by HTML(Hypertext Markup Language) so as to be suitable for a trade based on a web.

A customer database 132 stores information about a user who wants to receive a service, such as pregnancy, training, custody, quarantine, etc., with respect to a pet to be purchased or owned by the user. The information includes name, address, credit card number, telephone number, ID number, e-mail address, etc. Information of each item is arranged within fields such as a name field, and an address field.

A supplier database 134 stores information about a supplier, such as name, contact information, type of business, etc. with fields. The contact information includes telephone number, e-mail address, web page, facsimile number, address, etc. The supplier is an individual or an organization or a company that does business for pets. For example, a first supplier may be a business manager who operates an animal farm, a second supplier may be an animal hospital, and a third supplier may be an insurance company.

A purchase database 136 maintains information about all kinds of pets(dogs, cats, birds, etc.) that can be purchased on the server node 120, and fundamental purchage items(FPI) such as breed• sex• age• use (pet dog• Seeing Eye dog, etc.) of a specific pet(e.g., a dog or a cat), price, etc. Further, the purchase database 136, as items selectable by the customer, includes information about optional purchase items(OPI), such as vaccination, disease examination, delivery, and a micro chip purchase for recording histories of pet such as medication. The microchip is a product sold by the company, AVID or TROVON, and is able to record all information according to needs from birth of a pet. The purchase database 136 might maintain additionally information about requisite purchase items(RPI), such as insurance (charged or free of charge) against disease, or death by damage or disease within a certain period of time after purchase of pets. The RPI is obtained without a separate selection because it is an accompanying item after selection in the FPIs, which will be explained hereinafter.

A pregnancy database 138 includes necessary information with fields ranging from breeding to delivery(birth of cubs) such as kinds of breedable pets, desired species for breed, age, history, price, etc. It is appreciated that the information stored in the pregnancy database 138 is divided into FPIs, OPI, and RPI.

A training database 140 stores information, such as possibility of training, kinds of training, period, time, price, etc., according to pets. Information about vaccination necessary before training, conveyance when pets are admitted to or sent back from a training center, etc. may be included in OPI. Further, sickness insurance, damage or death causable during training may be further included in RPI.

A custody database 142 maintains information about pets, such as kind, age, size, weight, period, cage according to the kinds of pets, how to care, etc. Information about medical examination and vaccination upon request for custody, and embellishment during custody may be maintained in OPI. Information about insurance against possible damage caused during the period of custody may be included in RPI.

A funeral database 144 stores information about pets, such as kind, size, how to treat dead pets, price, etc.

A quarantine database 146 stores information about pets, such as kind, size, weight, country to go, and data on various vaccination, examination, issuance of certificate required according to regulations of the entry country, etc. Further, information about selection of a microchip, transfer of pets to an airport, and batch processing in case of plurality of entry countries, etc. may be included in OPI. Information about cargo insurance against loss, damage or death during transfer may be included in RPI.

A management database 148 stores general information, such as feeding, lodge, exercise, disease prevention, periodical vaccination, medical examination, etc. Further, the management database maintains, for individual management, information on a customer such as name, address, phone number, ID number, and on pets such as breed, sex, age, medical examination experience, disease history, etc.

A FPI database 152, an OPI database 152, and an RPI database 154 store information with fields about tracking number, day and time, subject area (purchase, training, quarantine, etc.), breed• sex• age• management number of pet, price, customer ID, supplier ID, etc.

A payment database 156 stores information about all payment made by the customer, such as customer name, customer ID, amount of payment, credit card number, etc.

If the customer logs on to the server node 120 acting as the central control system through Internet, a subject area page on a world wide web is displayed on the customer node 100. The subject areas include purchase, pregnancy, training, custody, funeral, quarantine, management, etc. When the customer selects one subject, e.g., selects the purchase, information about pets that can be purchased is displayed on the customer node 100. Then, when the customer selects a desired pet, e.g., a pet dog, the customer chooses the kind of the pet dog the customer wants to purchase while watching on-line catalogs on pet dogs.

When the kind of the pet dog is selected, an on-line request form is displayed on the customer node 100. The request form is a sort of electronic contract having a plurality of blanks to be filled out by the customer using a keyboard or a mouse. Completion of the electronic contract consists of three items, FPI, OPI, and RPI. The FPI mainly consists of particulars on common and traditional practices, custom and routine in a trade, which might be made through on-line or off-line in a pertinent subject area. The FPI includes minimum items which are fundamental for making a successful trade. For example, when the customer wants to purchase a peg dog, the customer has to select detailed items or contents in the FPI itself to specify the pet dog's kind, sex, age and the like that are required for purchase. The OPI is a sort of service that the customer can freely determine whether or not to additionally purchase with respect to the subject area. Thus, although the customer does not select the OPI, a trade can be automatically arranged by the selection in the FPI. The RPI is a service that the customer can automatically attain without a separate selection, once a specific item is selected from the FPI and so the trade is made. Even though the RPI is obtained with no regard to the customer's will, it goes without saying that the RPI can be canceled when the customer does not want the service. What is important is that the customer has to cancel the RPI as an action after a basic contract between the customer and the server is entered into. That is to say, the customer can express his/her intension of cancellation on the final point when the contract is completed, or before requirements of the RPI are not met after the contract is completed (e.g., in case of insurance, before an insurance contract is entered into with an insurance company).

Furthermore, the items or contents constituting the FPI, the OPI, and the RPI are exchangeable with one another by a request of parties concerned on the trade, such as the customer, the server and the supplier. This exchange may be made by the customer' request, or by the supplier' or the server' request. In case of insurance, one item can be simultaneously included in the FPI, the OPI, and the RPI by varying the contents compensated by the insurance.

The items will be hereinafter explained in detail subject area by subject area. For convenience in understanding and explanation, the description will be made herein below based on a pet dog as a pet.

Initially, in case that the subject area is the purchase, the FPI includes kind(e.g., spaniel, greyhound, etc.), sex, age, price, and so on. Thus, a specifying action should be made among particulars or contents constituting the FPI. The OPI contains grade of the dog (e.g., a breeding dog, a pedigree dog, etc.), vaccination, disease examination, microchip recording pet dog's history, conveyance (direct receipt by the customer, delivery by the supplier, and delivery by the third party), etc. The medical examination is divided into a general examination and an individual examination. The RPI includes monetary reward, insurance, medical cure service, and so forth as a way of compensating danger such as loss, disease, damage, or death by disease or damage happening within a certain period of time after purchase. The insurance is divided into charged insurance and free-of-charge insurance. By way of example, the free-of-charge insurance is designed to be effective when anybody other than the customer takes the responsibility for accident whereas the charged insurance is designed to be effective when the customer takes the responsibility for accident. In addition, subscription to the charged insurance may be classified into the OPI, and subscription to the free-of-charge insurance may be classified into the RPI. Whether or not to subscribe may be determined depending on the subject areas. Of course, the free-of-charge insurance may be classified into the FPI.

In case that the subject area is the pregnancy, the FPI includes desired breed, age• size• history of the selected breed, price, etc. Breeding, artificial insemination, selection of facility for breeding, number of time of breeding, etc. may be classified into the OPI. The breeding may be classified into the FPI, and the artificial insemination may be classified into the OPI. Both items, FPI and OPI might be designed to be exchangeable with each other according to the customer's request. The RPI may be a guaranty contract which provides a free-of-charge breeding within a predetermined number of time when the breeding is failed, or may be purchase of necessary goods at a reduced price from the supplier being a member of the server node 120.

In case that the subject area is the training, the FPI includes kinds of training (e.g., dog obedience training, defense dog training, police dog training, dog training for other purposes, etc.), period, place, price, etc. As the OPI, moving picture provision (provision of image data about training course and training result according to kinds of training), medical examination and vaccination before training, conveyance when the pet dog is sent to and back from the training center, etc. may be selected. The RPI may include insurance, charged or free of charge, against danger such as disease, damage, or death by disease or damage during training, purchase of necessary goods or utilization of facilities of the training center operated by the member supplier at a discount price, etc. The utilization of facilities or purchase of goods provided by the member supplier may be classified into the OPI. Otherwise, it may be designed to be changeable into the OPI according to the customer's request when trading.

In case that the subject area is the custody, the FPI is filled with kind, sex, age, size, weight, period, standard cage depending on pets, etc. The OPI may includes moving picture provision (picture information about pet hotel, cage, and custody life), medical examination• disease examination• embellishment, etc. during custody or when canceling custody. As the RPI, the items may by choosen such as insurance against accident causable during custody, and utilization of facilities or purchase of goods by the member supplier. Discount benefit may be given to the RPI.

In case that the subject area is the funeral, the FPI may have kind, size, way of treating dead pets(when a trader treats on his responsibility), price, etc. As the OPI, kind of funeral car, cremation, way of laying ashes, etc. may be selected. The RPI is not proper to the funeral, but a service provided by the member supplier on condition of a discount benefit may be selected as the RPI.

In case that the subject area is the quarantine, the FPI is determined pursuant to regulations of the quarantine laws enacted by countries. When the customer wants to enter or depart with the pet for emigration, study abroad, or long journey, since each country has its own quarantine law, the regulations of the quarantine law are different from country to country. That is to say, the items classified as the FPI such as disease prevention for country entry/departure (health certificate, rabies, vaccination, etc.), quarantine procedure and authority, quarantine conditions for a certain period of time before final entry permit, additional vaccination according to stay period in the entry country, etc. are determined by laws and regulations of the country concerned, and therefore the contents of FPI are different from contry to country. The OPI may include items such as pet transfer to a departure port, cage for loading on an airplane, batch processing when entry into several countries, etc. As the RPI, cargo insurance against damage or death due to stress during transportation, prior purchase from the member supplier with respect to goods including the cage necessary for transportation, etc. may be selected. The cargo insurance is divided into charged one and free-of-charge one. The charged insurance may be classified into the OPI while the free-of-charge insurance may be classified into the FPI.

In each subject area, the RPI may be designed to have sub optional items. That is, by way of example, in case of purchase, the RPI may maintain sub optional items, such as (1)free-of-charge insurance, (2)discount purchase, and (3)purchase of necessary goods from the member supplier having preferential favors like discount benefit. The customer can select one or more of the three sub optional items. By way of another example, when the subject area is the custody, (1)insurance, (2)purchase of necessary goods at a discount price from the member supplier, and (3)free-of-charge embellishment of pets may be provided as the sub optional items, and the customer can select one or more from the sub optional items. Further, for the purchase, the free-of-charge insurance may be classified into the FPI, the discount purchase into the OPI, and removal of parasites before delivery into the RPI.

Each supplier consisting of the plurality of supplier nodes 170 that constitute a part of the system for purchasing and managing pets according to the present invention is a businessman or a company that does pet business, preferably, a supplier in cooperation with the server.

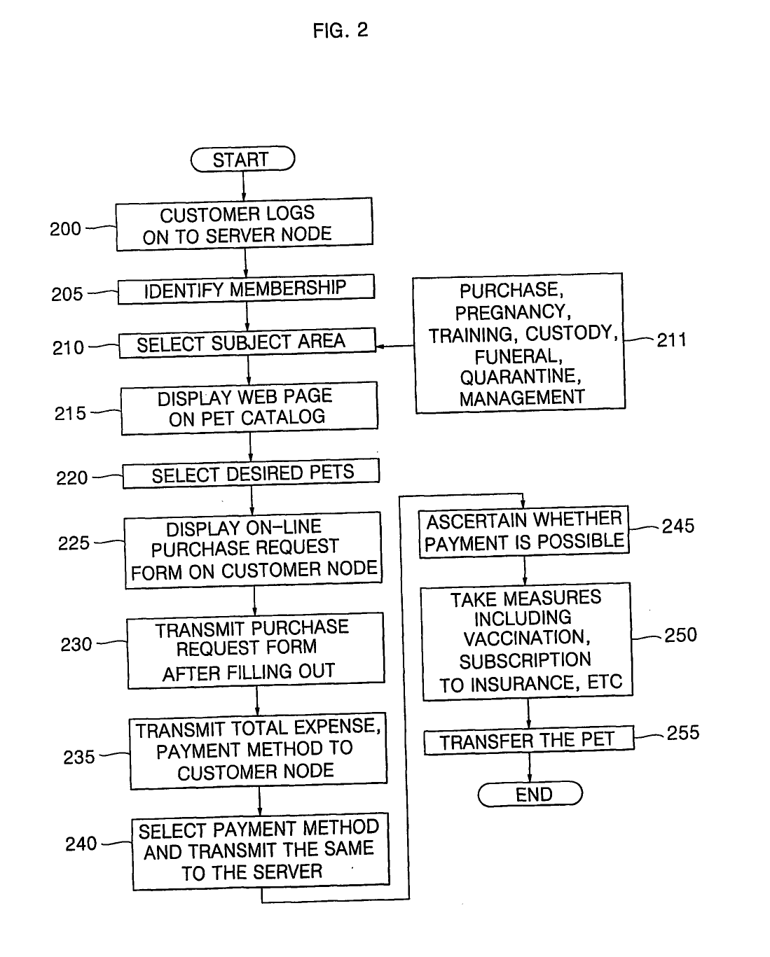

FIGS. 2 to 4 are flow charts illustrating processes of trading between the customer node 100 and the server node 120 according to a subject area selected. For explanation of the present invention, the processes for purchase, training, and quarantine are representatively shown among the subject areas.

Referring to FIG. 2, at step 200, the customer logs on to the server node 120 acting as the web server through Internet. At step 205, the server node 120 ascertains whether the customer is a member or not. In the negative, the server node 120 invites the customer to the membership, and gives the customer ID number when the customer becomes the member. At step 210, the customer selects a desired subject among subject areas on the web page displayed on a monitor. As shown in a box 211, the subject areas include purchase, pregnancy, training, custody, funeral, quarantine, and management.

Once the subject area is selected, a web page on a pet catalogue is displayed on the customer node 100. The catalogue contains various kinds of pets, image data and explanation of characteristics on the pets, price, and so on. At step 220, the customer selects a pet that the customer wants to purchase from the catalogue, and an on-line purchase request form is displayed on the customer node 100. The request form is a sort of electronic contract having a plurality of blanks to be filled out by the customer in accordance with instructions.

At step 230, the customer fills in the blanks in the request form in accordance with conditions that the customer desires to purchase. The request form includes FPI, OPI and RPI. The FPI may consist of kind, sex, age, price, etc., for example, of a pet dog. The customer fills in the FPI and then determines the OPI. The OPI may include vaccination, disease examination, way of delivery(direct receipt by the customer, or delivery by the supplier), etc. The customer can be given assistance with respect to the OPI, referring to information about the optional purchase. Further, the customer can get explanation about additional expense due to selection of each OPI.

For the RPI, the customer need not to make a separate selection or expression, but the customer can be assisted by explanation according to relevant information message. For example, the RPI may include compensation for disease, damage or death by disease or damage happening within a certain period of time after purchase. The compensation includes monetary reward, medical cure service, and is generally a pet insurance. However, when sub optional items are added to the RPI, the customer selects at least one among the sub optional items of the RPI again. That is, for example, when the plurality of sub optional items are included within the RPI, such as (1)subscription to free-of-charge insurance, (2)discount purchase, and (3)vaccination with delivery of the pet dog, the customer has to select at least one item among the three items according to regulations prescribed in the request form.

After receiving the request form from the customer, the server node 120 transmits particulars for purchase determination such as total expense and payment method (with credit card, GIRO, cash, etc.) in relation with purchase of the pet to the customer node 100 at step 235. At step 240, the customer selects a desired payment method, and transfers the same to the server node 120. At step 245, the server node 120 confirms whether the payment is possible, in case of purchase with credit card, and then settles expenses to be paid to the supplier.

At step 250, the vaccination, subscription of insurance, and the like are performed in accordance with the purchase items purchased by the customer through the request form. At step 255, the pet is transferred to the customer according to the method prescribed in the request form, thereby finishing the process for purchasing the pet.

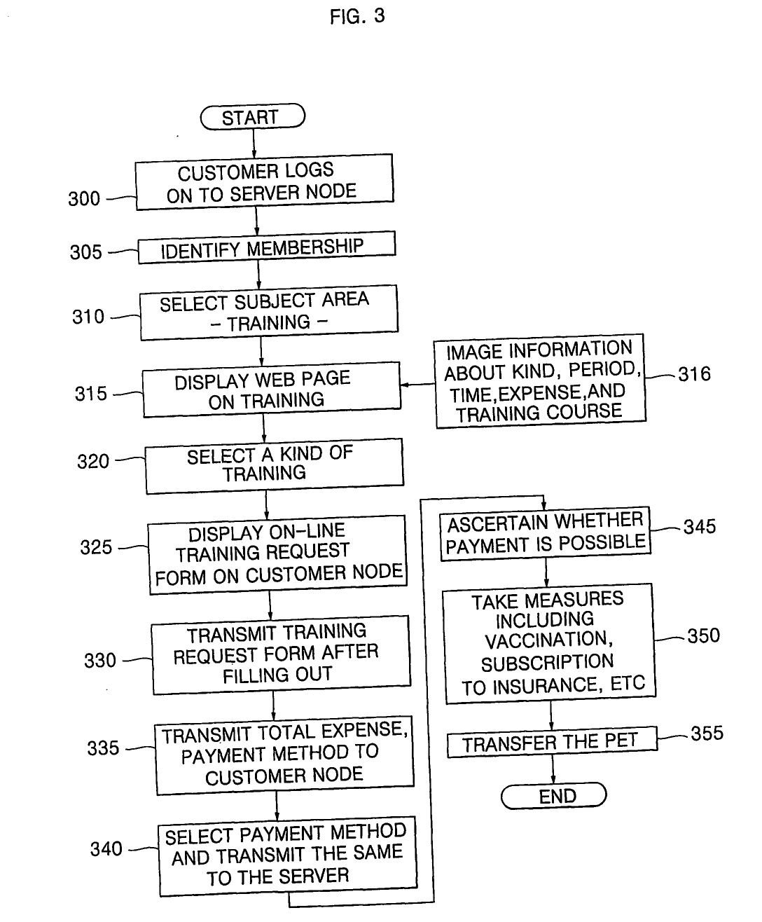

FIG. 3 illustrates a process of training a pet. For convenience of explanation, description will be made based on the dog whose training has been most universally developed. At steps 300 and 305, the customer logs on to the server node 120, is identified whether the customer is a member, and then the customer is invited to the membership.

At step 310, when the training is selected as the subject area, the web page relating to training is displayed on the customer node 100. The contents of training includes kinds of training, period, time, cost, image data of training course, etc. as shown in a box 316. At step 320, the customer selects a desired kind of training on the web page, and at step 325, an on-line training request form is displayed on the customer node 100.

The on-line training request form is basically divided into three purchase items. The FPI includes kinds of training, period, time, price, etc. Free-of-charge insurance against accident occurring during training may be selected as the FPI. The OPI may include vaccination before training, conveyance when the pet is sent to and sent back from a training center, etc. The RPI includes insurance against accident happening during training, ufilization of facilities provided by the member supplier at a discount price, etc.

At step 330, the customer fills in the desired purchase items with necessary information, and transmits the training request form to the server node 120. At steps 335, 340, and 345, costs, payment method, supplier expenses, etc. are processed. At step 350, vaccination, subscription to insurance or the like in accordance with the purchase items selected through the training request form by the customer is carried out. At step 355, the pet is transferred from the customer to the training center, or from the training center to the customer (after the end of training), thereby finishing the training course.

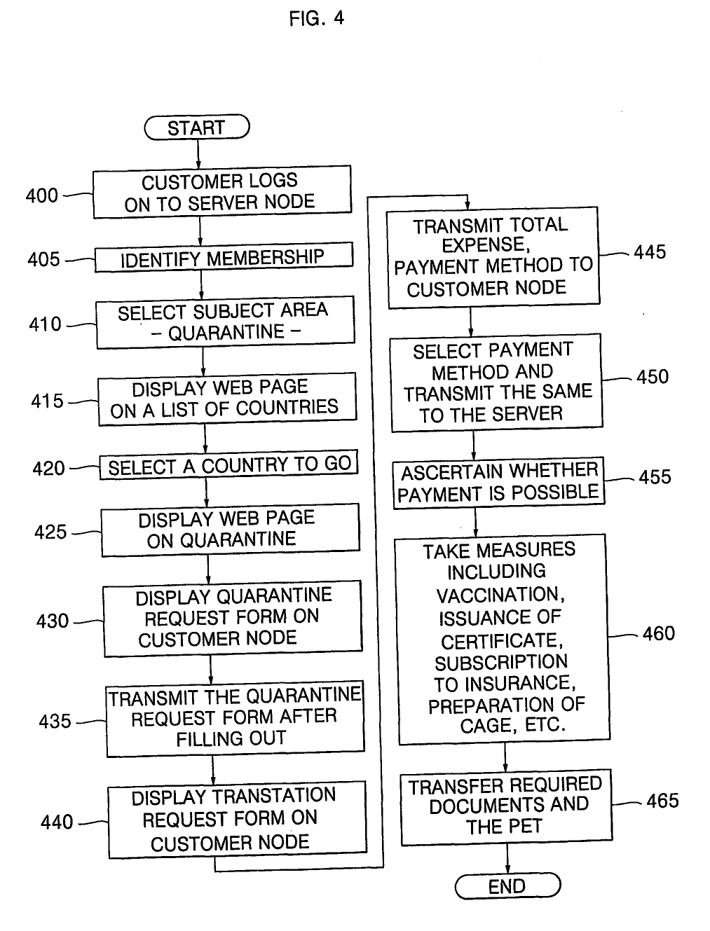

FIG. 4 illustrates a process for quarantine to be fulfilled when the customer emigrates, goes abroad for study, and goes on a long business trip with the pet. At steps 400 and 405, the customer logs on the server node 120, and a membership confirmation is performed. Then, at 410, the customer selects the quarantine as the subject area.

At step 415, a web page on a list of countries that require quarantine is displayed on the customer node 100. At step 420, the customer selects a country to go. At step 425, a web page containing detailed information about the quarantine law of the pertinent country is displayed.

If the customer requests for a quarantine request form, at step 430, the quarantine request form is displayed on the customer node 100. The quarantine request form has the FPI that includes quarantine matters provided by the entry country. Cargo insurance against damage due to accident happening while the pet is transferred via an air cargo may be classified into the FPI. The OPI may include pet transfer to the departure air port, cage for loading on a plane, etc. The RPI includes cargo insurance against damage or death due to stress or accident during transportation, prior purchase of products from the member supplier, etc.

Uopn demand of the customer after the quarantine request form is transmitted, at step 440, a transportation request form is also transmitted to the customer node 100. The transportation request form is constructed such that the customer can select the way of pet transfer to the air port, cage for load on the plane, price, etc.

At steps 445, 450, and 455, communication is made between the customer and the server node 120 in regard to total expenses and payment method.

At step 460, vaccination, issuance of certificate, subscription to insurance, preparation of cage, etc. are carried out in accordance with the contents purchased by the customer through the quarantine request form and the transportation request form. At step 465, the required documents and the pet are transferred, thereby finishing the quarantine procedure.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

As described above, the present invention has an advantage of saving times and efforts consumed since the customer can purchase a wanted pet even at a remote distance by using a computer communication network.

The quarantine procedure is complicated and troublesome for the customer. Further, when the customer directly takes the procedure, often the customer fails to take the procedure for country entry and departure because of lack of knowledge of relevant authorities and exact information about each country's law. The present invention can settle this kind of problem.

Additionally, the present invention has still another advantage of achieving efficiency in management of pets since the customer can be compensated by virtue of the insurance against disease, damage, loss or death by disease or damage generated after purchase of the pet.

The present invention has yet another advantage of offering wide range of selection to the customer and providing various benefits since items purchasable by the customer are classified into fundamental items, optional items, and requisite items.

What is claimed is:

1. A computer system for purchasing and managing pets, the computer system comprising:
a customer node;
a server node being connected to said customer node by a computer network, and having a database storing information about pets;
said server node being configured to transmit said information about pets to said customer node in response to a request from said customer node so as to display said information about pets on said customer node; and
said server node being further configured, in order to meet a purchase request from said customer node, to include a fundamental purchase item which is selected by a customer to achieve a desired purchase, and a requisite purchase item which is attained without a separate selection once a purchase procedure has been arranged between said customer node and said server node by selecting said fundamental purchase item.

2. The computer system of claim 1, wherein said purchase request is a purchase, and said requisite purchase item includes an insurance against danger causable to said pets after purchasing said pets.

3. The computer system of claim 2, wherein said insurance is free of charge.

4. The computer system of claim 2, wherein said insurance is free of charge when said customer is a member.

5. The computer system of claim 1, wherein said requisite purchase item includes a plurality of sub optional items, and wherein said customer further makes a separate selection among said plurality of optional items after said purchase procedure has been completed with the selection of said fundamental purchase item by said customer.

6. The computer system of claim 5, wherein said sub optional items include pet insurance, and purchase of goods provided by a member supplier with a preferential benefit.

7. The computer system of claim 1, wherein said fundamental purchase item includes an insurance against danger causable to said pets after purchasing said pets.

8. The computer system of claim 7, wherein said insurance is free of charge.

9. The computer system of claim 1, wherein said requisite purchase item is cancelable by said customer.

10. The computer system of claim 5, wherein said customer is able to cancel at least one in the at least one optional item selected among said plurality of optional items.

11. The computer system of claim 1, wherein said purchase request is pregnancy of pet, and said requisite purchase item includes a guaranty contract which provides a free-of-charge breeding when the pregnancy is failed.

12. The computer system of claim 11, wherein said fundamental purchase item includes an artificial insemination so that said customer can select said artificial insemination as a breeding method.

13. The computer system of claim 1, wherein said purchase request is a training of pets, and said requisite purchase item includes an insurance against danger causable during the training.

14. The computer system of claim 1, wherein said purchase request is a custody of pets, and said requisite purchase item includes an insurance against danger causable during said custody.

15. The computer system of claim 1, wherein said purchase request is a quarantine of pets, and said requisite purchase item includes an insurance against danger causable during delivery of the pet.

16. The computer system of claim 15, wherein said insurance is free of charge.

17. The computer system of claim 1, wherein said requisite purchase item includes an insurance against danger causable after purchasing said pets.

18. The computer system of claim 17, wherein said insurance is free of charge.

19. A method for making a trade between a customer and a server system through a network with respect to pets, the method comprising the steps of:
transmitting a service request from said customer to said server system;
transmitting a request form to said customer together with information about said pets in response to said service request from said customer, said request form including a plurality of fundamental purchase items at least one of which is selected by said customer when said customer wants to purchase, and a requisite purchase item which is attained without a separate selection once a trade has been made with a selection of at least one of said fundamental purchase items by said customer; and
selecting at least one of said fundamental items by said customer.

20. The method of claim 19, wherein said service request is a purchase of pets, and said requisite purchase items includes an insurance against danger causable after purchasing said pets.

21. The method of claim 20, wherein said insurance is free of charge.

22. The method of claim 19, wherein said requisite purchase item includes a plurality of sub optional items, and further comprising the step of selecting at least one among said sub optional items.

23. The method of claim 19, wherein said fundamental purchase items include an insurance against danger causable after purchasing said pets.

24. The method of claim 19, further comprising the step of canceling said requisite purchase item determined following the selection in said fundamental purchase items by said customer.

25. The method of claim 22, further comprising the step of canceling at least one in the at least one sub optional item selected among said sub optional items.

26. The method of claim 19, wherein said service request is a quarantine of pets, and said requisite purchase item includes an insurance against danger causable during transportation of said pets.

27. The method of claim 26, wherein said insurance is free of charge.

28. A system for purchasing and managing pets, the system comprising:
a customer node;
a server node being connected to said customer node by a computer network, and having a database storing information about pets;
said server node being configured to transmit said information about pets to said customer node in response to a request from said customer node so as display said information about pets on said customer node, and being further configured to include a fundamental purchase item which has minimum items required to arrange a trade with a customer, and at least one optional purchase item which is voluntarily selectable by said customer when necessary; and
said server node being still further configured to include a requisite purchase item which is attained without a separate selection when the trade has been arranged by the customer's selection of said fundamental and optional purchase items.

29. The computer system of claim 28, wherein said fundamental purchase item, said optional purchase item, and said requisite purchase item are exchangeable with one another according to a request by parties concerned when trading.

30. The computer system of claim 29, wherein the exchange is made by a request from said customer.

31. The computer system of claim 28, wherein said fundamental purchase item includes an insurance against danger causable after purchasing said pets.

32. The computer system of claim 31, wherein said insurance is free of charge.

33. The computer system of claim 28, wherein said optional purchase item includes an insurance against danger causable after purchasing said pets.

34. The computer system of claim 28, wherein said requisite purchase item includes an insurance against danger causable after purchasing said pets.

35. The computer system of claim 34, wherein said insurance is free of charge.

36. The computer system of claim 28, wherein said trade with said customer is purchase of pets, and said requisite purchase item includes an insurance against danger causable after purchasing said pets.

37. The computer system of claim 36, wherein said insurance is free of charge.

38. The computer system of claim 28, wherein said requisite purchase item includes a plurality of sub optional items, and wherein said customer further makes a separate selection among the sub optional items after purchase processes have been completed by the selection of said fundamental item.

39. The computer system of claim 28, wherein said requisite purchase item is cancelable by said customer.

40. The computer system of claim 38, wherein said customer can cancel at least one in the at least one sub optional item selected among said sub optional items.

41. The computer system of claim 28, wherein said trade with said customer is pregnancy of pets, and said requisite purchase item includes a guaranty contract which provides a free-of-charge breeding when the pregnancy is failed.

42. The computer system of claim 41, wherein said fundamental purchase item includes an artificial insemination so that said customer can select the artificial insemination as a breeding method.

43. The computer system of claim 28, wherein said trade with said customer is quarantine of pets, and said requisite purchase item includes an insurance against danger causable during transportation of said pets.

44. The computer system of claim 43, wherein said insurance is free of charge.

45. A method for making a trade between a customer and a server system through a network with respect to pets, the method comprising the steps of:
transmitting a service request from said customer to said server system;
transmitting a request form to said customer along with information about said pets in response to said service request from said customer, said request form including a plurality of fundamental purchase items at least one of which is selected by said customer to arrange said trade with said customer when said customer wants to make a trade, at least one optional purchase item which is voluntarily selectable by said customer when necessary, and a requisite purchase item which is attained without a separate selection when the trade has been arranged by the customer's selection of at least one among said fundamental purchase items; and
selecting at least one among said fundamental purchase items by customer.

46. The method of claim 45, wherein said trade with said customer is a purchase of pets, and said requisite purchase items include an insurance against danger causable after purchasing said pets.

47. The method of claim 46, wherein said insurance is free of charge.

48. The method of claim 45, wherein said requisite purchase item includes a plurality of sub optional items, and further comprising the step of selecting at least one among said sub optional items.

49. The method of claim 45, wherein said fundamental purchase items include an insurance against danger causable after purchasing said pets.

50. The method of claim 45, further comprising the step of cacelling said requisite purchase item determined following the selection in said fundamental purchase items by said customer.

51. The method of claim 48, further comprising the step of cancelling at least one in the at least one sub optional item selected among said sub optional items.

52. The method of claim 45, further comprising the step of exchanging said fundamental purchase items and said optional purchase item and said requisite purchase item with one another pursuant to the request of by parties concerned on the trade.

53. The method of claim 52, wherein said exchange is made by a request from said customer.

54. The method of claim 45, wherein said trade with said customer is a quarantine of pets, and said requisite purchase item includes an insurance against danger causable during transportation of the pet.

55. The method of claim 54, wherein said insurance is free of charge.

56. A system for purchasing and managing pets, the system comprising:
a customer node;
a server node being connected to said customer node by a communication network and having a database storing information about pets;
said server node being configured to transmit said information about pets to said customer node in response to a request from said customer node so as to display said information about pets on said customer node; and
said server node also including a plurality of selectable subject areas and a request form, said request form including a plurality of fundamental purchase items which are selected by a customer to arrange a desired purchase, and a requisite purchase item which is attained without a separate selection when a purchase procedure has been arranged between said customer node and said server node by the customer's selection of said fundamental purchase items.

57. The system of claim 56, wherein said subject areas include purchase, pregnancy, training, custody, funeral, and quarantine.

58. The system of claim 57, wherein said requisite purchase item includes an insurance against accident causable to the pet.

59. The system of claim 57, wherein said requisite purchase item includes a plurality of sub optional items, and wherein said customer further makes a separate selection among said sub optional items after said purchase procedure has been completed with the selection of said fundamental purchase items by said customer.

60. The system of claim 56, wherein said requisite purchase item is cancelable by said customer.

61. The system of claim 59, wherein said customer can cancel at least one in the at least one sub optional item selected among said sub optional items.

62. The system of claim 56, wherein said fundamental purchase items include an insurance against accident causable to the pet.

63. The system of claim 57 or 62, wherein said insurance is free of charge.
